(19) United States
(12) Patent Application Publication
(10) Pub. No.: US 2020/0016798 A1
(43) Pub. Date: Jan. 16, 2020

(54) METHODS OF FORMING WRAPPED COMPONENTS WITH REUSABLE INJECTION MOLDED THIN WALLED DUMMY SKINS AND WRAPPED COMPONENTS FORMED THEREFROM

(71) Applicant: Ford Motor Company, Dearborn, MI (US)

(72) Inventors: Bari Brown, Ann Arbor, MI (US); Manoj Patnala, Canton, MI (US)

(73) Assignee: Ford Motor Company, Dearborn, MI (US)

(21) Appl. No.: 16/031,263

(22) Filed: Jul. 10, 2018

(51) Int. Cl. B29C 44/12; B32B 5/18; B32B 9/02; B32B 7/12

(52) U.S. Cl. CPC B29C 44/1252; B32B 5/18; B29K 2075/00; B32B 7/12; B32B 9/025

(57) ABSTRACT

A method of forming wrapped components includes positioning an injection molded skin in a mold, forming a foam-in-place (FIP) foam substrate against the injection molded skin, removing the injection molded skin from the FIP foam substrate, bonding an external wrap to the FIP foam substrate, and reusing the injection molded polyolefin skin to form additional FIP foam substrates. A spacer layer may be bonded between and to the FIP foam substrate and the external wrap. The injection molded skin may be formed from a polyolefin polymer and may be a thermoplastic elastomer such as a thermoplastic vulcanizate. The FIP foam substrate may a FIP urethane foam substrate and the external wrap may be a leather wrap or a faux leather wrap. The injection molded skin reusable and may used a predetermined number of times, e.g., at least ten times, before being replaced by a replacement injection molded skin.

### FIELD

The present disclosure relates to wrapped components with an external wrap bonded to a substrate, and particularly, to methods of forming wrapped components with an external wrap bonded to a substrate using reusable injection molded removable dummy skins.

### BACKGROUND

The statements in this section merely provide background information related to the present disclosure and may not constitute prior art.

Components such as vehicle instrument panels, vehicle center consoles, furniture arm rests, etc., are conventionally manufactured by forming a substrate with a desired shape and covering or “wrapping” the substrate with an external wrap. A base or economy model of such a “wrapped component” may include an external wrap (also known as and referred to herein as a “skin”) formed from a polymer such as polyvinyl chloride (PVC), while a high end or luxury model of the wrapped component may include an external wrap formed from leather, faux leather, and the like. Also, the luxury model may include a spacer layer underneath the external wrap to ensure the wrapped component has a ‘soft’ or ‘plush’ feel and appearance.

Luxury models of wrapped components may be formed by wrapping economy models with additional layers. For example, a spacer layer and a leather layer may be applied or wrapped onto a PVC skin of an economy model wrapped component in order to form a luxury model of the wrapped component. In such instances, the PVC skin is known as a “dummy” skin or a dummy layer since it serves no function except to provide a surface for the spacer layer and the leather layer to be applied. However, a dummy skin adds weight and costs to a wrapped component.

These issues with wrapped components using dummy skins are addressed by the present disclosure.

### SUMMARY

In one form of the present disclosure, a method of forming a wrapped component includes positioning an injection molded skin in a mold, forming a foam-in-place (FIP) foam substrate against the injection molded skin, removing the injection molded skin from the FIP foam substrate, and bonding an external wrap to the FIP foam substrate to form a wrapped component. In some aspects of the present disclosure, a spacer layer is bonded to the FIP foam substrate and the external wrap is bonded to the spacer layer. The injection molded skin is reusable and is subsequently positioned in the mold to form another wrapped component. The injection molded skin may have a thickness between about 0.5 millimeters (mm) and about 1.5 mm and may be formed from a polyolefin polymer. For example, the injection molded skin may be a thermoplastic elastomer (TPE) such as a thermoplastic vulcanizate (TPV). The FIP foam substrate may be formed from urethane and may have a thickness between about 2.0 mm and about 20.0 mm. The external wrap may be a leather wrap or a faux leather wrap. The method may include forming a replacement injection molded skin after the injection molded skin is used a predetermined number of times. The replacement injection molded skin may be formed with a cycle time of less than about 120 seconds, thereby allowing replacement of the injection molded skin to be manufactured in a timely manner.

In another form of the present disclosure, a method of forming a plurality of instrument panels includes the steps of: (a) positioning an injection molded removable skin formed from a polyolefin polymer in a mold; (b) forming a foam-in-place (FIP) urethane foam substrate between a substrate backing layer and the injection molded removable skin; (c) forming an outer surface on the FIP urethane foam substrate by removing the injection molded removable skin from the FIP urethane foam substrate; (d) bonding an external wrap to the outer surface of the FIP urethane foam substrate to form an instrument panel; and (e) repeating steps a-d using the same injection molded removable skin to form additional instrument panels. The method may include forming a replacement injection molded removable skin formed from a polyolefin polymer after the injection molded removable skin is used a predetermined number of times. The injection molded removable skin may be formed with a cycle time of less than about 120 seconds and be formed from a thermoplastic elastomer (TPE), for example a thermoplastic vulcanizate (TPV). The injection molded removable skin may have a thickness between about 0.5 mm and about 1.5 mm, and the FIP urethane foam substrate may have a thickness between about 2.0 mm and about 20.0 mm. The external wrap may be formed from leather or a faux leather. In some aspects of the present disclosure, a spacer layer is bonded to the outer surface of the FIP urethane foam substrate and the external wrap is bonded to the spacer layer such that the external wrap is bonded to the outer surface through the spacer layer.

In still another form of the present disclosure, a method of forming a plurality of instrument panels with an exterior leather or faux leather surface includes positioning an injection molded removable skin formed from a polyolefin polymer and a substrate backing layer in a foam-in-place (FIP) mold. In some aspects of the present disclosure, the injection molded removable skin is spaced apart from the substrate backing layer by a distance between about 2.0 mm and about 20.0 mm. An instrument panel pre-form is formed by forming and bonding an FIP urethane foam substrate between the substrate backing layer and the injection molded removable skin. The pre-form is removed from the FIP mold and the injection molded removable skin is removed from the FIP urethane foam substrate. Removing the injection molded removable skin from the FIP urethane foam substrate forms an outer surface on the FIP urethane foam substrate and an external wrap may be bonded to the outer surface to form an instrument panel. In some aspects of the present disclosure, a spacer layer may be bonded to the outer surface of the FIP urethane foam substrate and the external wrap is bonded to the spacer layer to form the instrument panel. The steps of forming the instrument panel, i.e., the steps of: (a) positioning an injection molded removable skin; (b) forming an FIP urethane foam substrate between the substrate backing layer and the injection molded removable skin; (c) removing the injection molded removable skin from the FIP urethane foam substrate; and (d) bonding an external wrap to an outer surface of the FIP urethane foam substrate, may be repeated using the same injection molded removable skin to form at least 10 additional instrument panels. That is, the injection molded removable skin is reusable and may be used multiple times before a replacement injection molded removable skin is used to form additional instrument panels.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a wrapped component formed according to a prior art method;

FIG. 1A is a cross-sectional view of section A-A in FIG. 1;

FIG. 2 is a schematic illustration of a process for forming a wrapped component according to the teachings of the present disclosure;

FIG. 3 is a schematic illustration of a foam-in-place (FIP) mold with an injection molded removable skin positioned within a cavity of the FIP mold according to the teachings of the present disclosure;

FIG. 4 is a schematic illustration of the FIP mold in FIG. 3 with an FIP die positioned within the cavity of the FIP mold according to the teachings of the present disclosure;

FIG. 5 is a schematic illustration of the FIP mold and FIP die in FIG. 4 with an FIP substrate formed against the injection molded removable skin according to the teachings of the present disclosure;

FIG. 6 is a perspective view of a wrapped component formed according to the teachings of the present disclosure;

FIG. 6A is a cross-sectional view of section A-A in FIG. 6; and

FIGS. 7A-7F is a schematic illustration of steps for forming a wrapped component according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

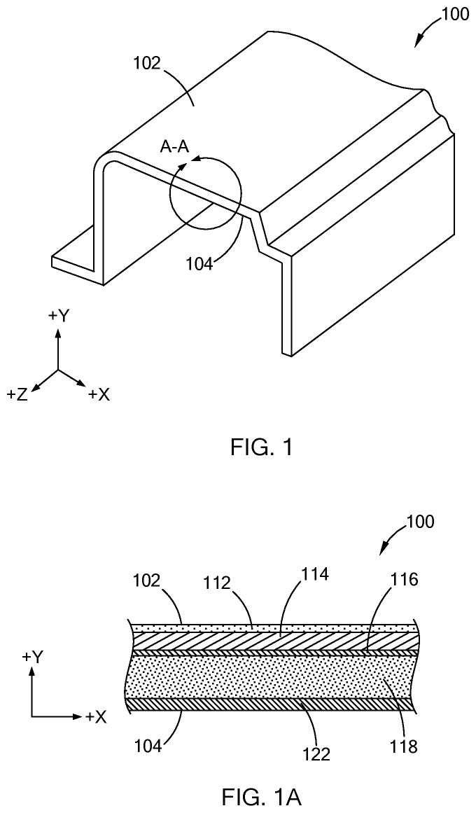

Referring to FIG. 1, a wrapped component 100 formed by a prior art method is shown. The wrapped component 100 has an outer surface 102 and an inner surface 104. As used herein, the phrase “wrapped component” refers to an object comprising a substrate and an external layer of material covering and attached to at least one surface of the substrate. The phrase “outer surface” refers to a surface of a wrapped component facing towards an individual using the wrapped component as opposed to an “inner surface” facing away from an individual using the wrapped component. Non-limiting examples of wrapped components include vehicle components such as an instrument panel (IP), a center console, a door rollover, a door arm rest, and the like, and furniture components such as a chair or sofa arm, a chair or sofa seat, a chair or sofa leg support, and the like. Accordingly, the outer surface 102 of the wrapped component 100 may be a surface of a vehicle IP, center console, door arm rest, etc., facing towards an individual sitting in a vehicle whereas the inner surface 104 may be a surface facing away from the individual sitting in the vehicle.

The wrapped component 100 may include a number of layers between the outer surface 102 and the inner surface 104 as schematically depicted in FIG. 1A. For example, the wrapped component 100 may include an external wrap layer 112, a spacer layer 114 adjacent and bonded to the external wrap layer 112, a dummy layer 116 adjacent and bonded to the spacer layer 114, an FIP substrate 118 adjacent and bonded to the dummy layer 116, and a substrate backing layer 122 adjacent and bonded to the FIP substrate 118. As used herein, the term “wrap” or “wrap layer” refers to a layer or sheet of material that is bonded to a surface and the phrase ‘external layer” or “external wrapped layer” refers to a layer or sheet of material that is an outermost layer of a wrapped component described herein. A process for manufacturing such a wrapped component 100 may generally include positioning the dummy layer 116 within a mold cavity of an FIP mold and then positioning an FIP die with the substrate backing layer 122 attached thereto within the mold cavity such that the substrate backing layer 122 is spaced apart from the dummy layer 116 and a gap is present therebetween. The gap is filled with foam using an FIP process thereby forming a pre-form (not shown) comprising the FIP substrate 118 bonded to and between the dummy layer 116 and the substrate backing layer 122. The pre-form is typically removed from the FIP mold and the spacer layer 114 and the external wrap 112 are attached to the dummy layer 116 to form the wrapped component 100.

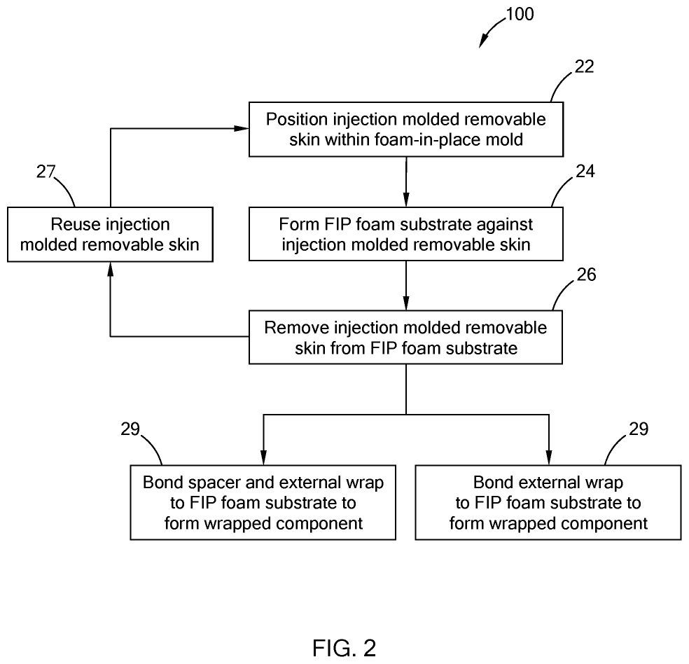

Referring now to FIG. 2, a schematic illustration of a process 20 for forming a wrapped component according to the teachings of the present disclosure is shown. The process 20 generally includes using an injection molded skin that can be removed from an FIP foam substrate (herein referred to as an “injection molded removable skin”) and reused in forming of additional wrapped components. The process 20 includes positioning an injection molded removable skin within an FIP mold at step 22 and forming an FIP foam substrate against the injection molded removable skin to provide a pre-form of the wrapped component at step 24. The injection molded removable skin may be free of flame treatment prior to positioning within the FIP mold at step 22 and forming the FIP foam substrate against the injection molded removable skin. That is, if the injection molded removable skin is flame treated prior to forming the FIP foam substrate, then the injection mold removable skin may adhere to the FIP foam substrate such that it is difficult to remove therefrom and/or may rip or tear when removed therefrom. Accordingly, if the injection removable skin is not flame treated prior to positioning within the FIP mold it may be more easily removed from the FIP foam substrate. As used herein, the phrases “flame treated”, “flame treatment” and “flame treating” refer to application of a gas flame on a surface of a material to improve adhesion of the surface to another surface.

In some aspects of the present disclosure, the pre-form is formed by bonding the FIP foam substrate to and between the injection molded removable skin and a substrate backing layer attached to an FIP die. The injection molded removable skin is separated (removed) from the FIP foam substrate at step 26 and reused at step 27 to form additional FIP substrates at steps 22 and 24. In other aspects of the present disclosure, the pre-form is removed from the FIP mold and then the injection molded removable skin is separated (removed) from the FIP foam substrate at step 26 and reused at step 27 to form additional FIP substrates at steps 22 and 24.

The injection molded removable skin may be reused more than 10 times. For example, the injection molded removable skin may be reused more than 20 times, 30 times, 40 times, 50 times or more than 60 times to form additional FIP substrates in steps 22 and 24. That is, the injection molded removable skin may be reused between 10 to 20 times, between 20 to 30 times, between 30 to 40 times, between 40 to 50 times, between 50 to 60 times, or more than 60 times to form additional pre-forms at steps 22 and 24. In one form of the present disclosure, a spacer layer is bonded to the FIP foam substrate and an external layer is bonded to the spacer layer at step 28. In another form of the present disclosure, the external wrap is bonded directly to the FIP foam substrate at step 29, i.e., a spacer layer is not bonded to and between the FIP foam substrate and the external wrap.

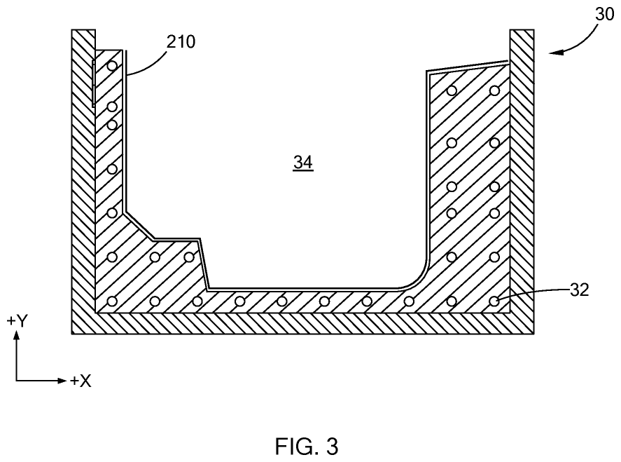

Referring now to FIG. 3, a schematic illustration of an FIP mold 30 with a mold cavity 34 is shown. The FIP mold 30 may include optional heater elements 32 to provide heat during the FIP process. An injection molded removable skin 210 may be positioned within the mold cavity 34 (step 22 of process 20). In some aspects of the present disclosure, the injection molded removable skin 210 may be held within the mold cavity 34 using vacuum. That is, vacuum (suction) through the walls (not labeled) of the FIP mold 30 hold the injection molded removable skin 210 up against the walls and surfaces (not labeled) of the mold cavity 34 during the FIP process. The injection molded removable skin 210 may be formed from a thermoplastic elastomer (TPE) and may have a thickness between about 0.5 millimeters (mm) and about 20.0 mm. Non-limiting examples of a TPE include thermoplastic vulcanizates (TPV), thermoplastic olefins (TPO), thermoplastic polyolefins (TPOs), and the like, that can be separated from an FIP foam substrate without tearing of the injection molded removable skin 210 or the FIP foam substrate. Also, the injection molded removable skin 210 may be free of flame treatment (i.e., not subjected to flame treatment). In some aspects, the injection molded removable skin 210 may have a thickness between about 0.5 mm and about 10.0 mm. For example, the injection molded removable skin 210 may have a thickness between about 0.5 mm and about 1.0 mm, between about 1.0 mm and about 1.5 mm, between about 1.5 mm and about 2.0 mm, between about 2.0 mm and about 3.0 mm, between about 3.0 mm and about 4.0 mm, between about 4.0 mm and about 5.0 mm, between about 5.0 mm and about 6.0 mm, between about 6.0 mm and about 7.0 mm, between about 7.0 mm and about 8.0 mm, between about 8.0 mm and about 9.0 mm, or between about 9.0 mm and about 10.0 mm.

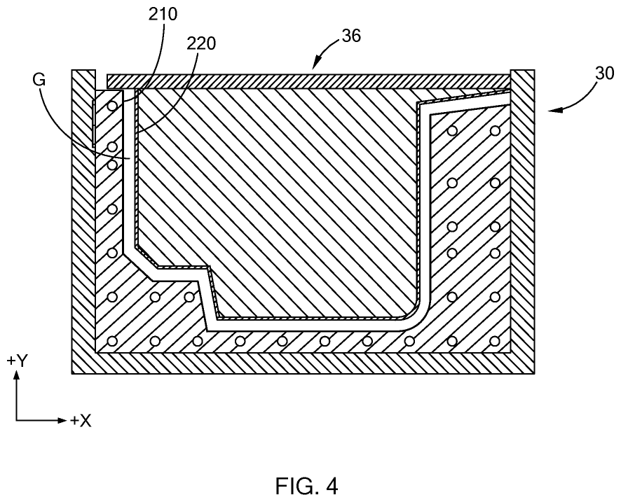

Referring now to FIG. 4, a schematic illustration of the FIP mold 30 with an FIP die 36 positioned within the mold cavity 34 is shown. In some aspects of the present disclosure, a substrate backing layer 220 is removably attached to the walls (not labeled) of the FIP die 36. Similar to the injection molded removable skin 210 being removably attached to the walls of the mold cavity 34, the substrate backing layer 220 may be removably attached to the walls of the FIP die 36 using vacuum. In other aspects of the present disclosure, a substrate backing is not removably attached to the walls (not labeled) of the FIP die 36 and an FIP foam substrate is formed between the FIP die 36 and the injection molded removable skin 210. In such an aspect, the walls of the FIP die may include a release agent that results in the FIP foam substrate not adhering or sticking to the walls of the FIP die after a pre-form (not labeled in FIG. 4) has been formed and the FIP die 36 is removed from the mold cavity 34.

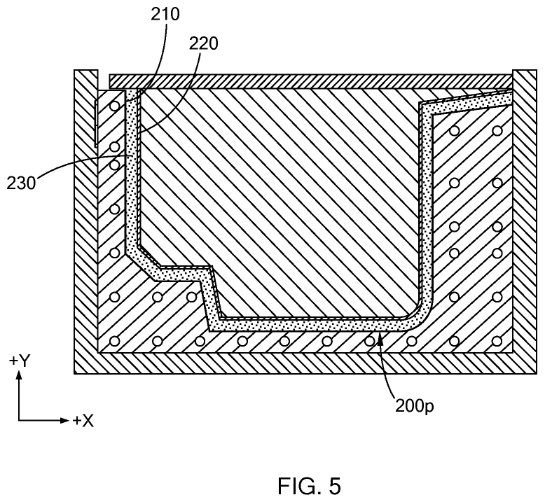

The FIP die 36, with or without the substrate backing layer 220, may have a shape that is complimentary with a shape of the FIP mold 30 such that walls (not labeled) of the FIP die 36 are spaced apart from the injection molded removable skin 210 positioned within the mold cavity 34. That is, a gap ‘G’ may be provided between the injection molded removable skin 210 and the substrate backing layer 220 (and the walls of the FIP die 36) as schematically depicted in FIG. 4. It should be understood that the gap G allows for foam to be disposed (e.g., inserted and formed) between the injection molded removable skin 210 and the substrate backing layer 220 (and the walls of the FIP die 36). That is, the gap G allows a FIP foam substrate 230 to be formed and a pre-form 200p comprising the injection molded removable skin 210, the substrate backing layer 220, and the FIP foam substrate 230 to be provided as schematically depicted in FIG. 5.

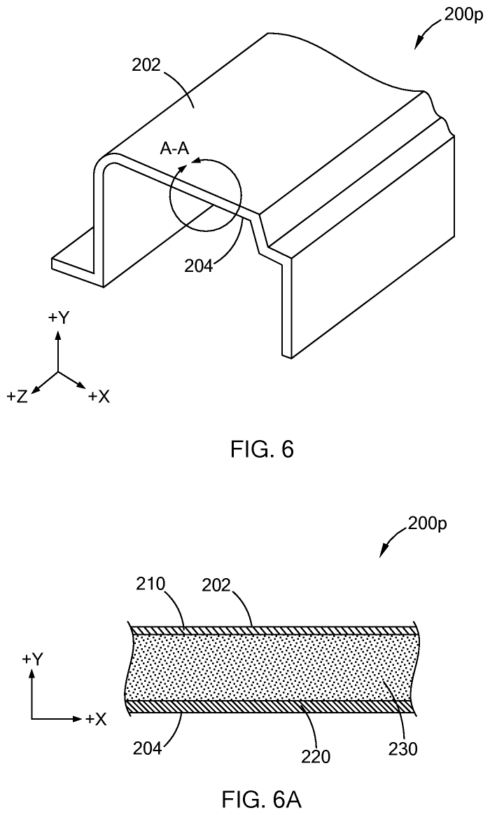

Referring now to FIGS. 6 and 6A, a perspective view of the pre-form 220p after being removed from the FIP mold 30 is schematically depicted in FIG. 6 and a cross-section of section A-A in FIG. 6 is schematically depicted in FIG. 6A. The pre-form 200p includes an outer surface 202 and an inner surface 204. Extending between the outer surface 202 and the inner surface 204 are the injection molded removable skin 210, the substrate backing layer 220, and the FIP foam substrate 230 positioned between and bonded to the injection molded removable skin 210 and the substrate backing layer 220.

While FIG. 6A schematically depicts only three layers, i.e., the injection molded removable skin 210, the substrate backing layer 220, and the FIP foam substrate 230, it should be understood that in some aspects of the present disclosure additional layers may be included between the outer surface 202 and the inner surface 204 of the pre-form 220p. Non-limiting examples of additional layers include adhesive layers, filler layers, support layers, and the like, between the injection molded removable skin 210 and the FIP foam substrate 230 and/or between the substrate backing layer 220 and the FIP foam substrate 230.

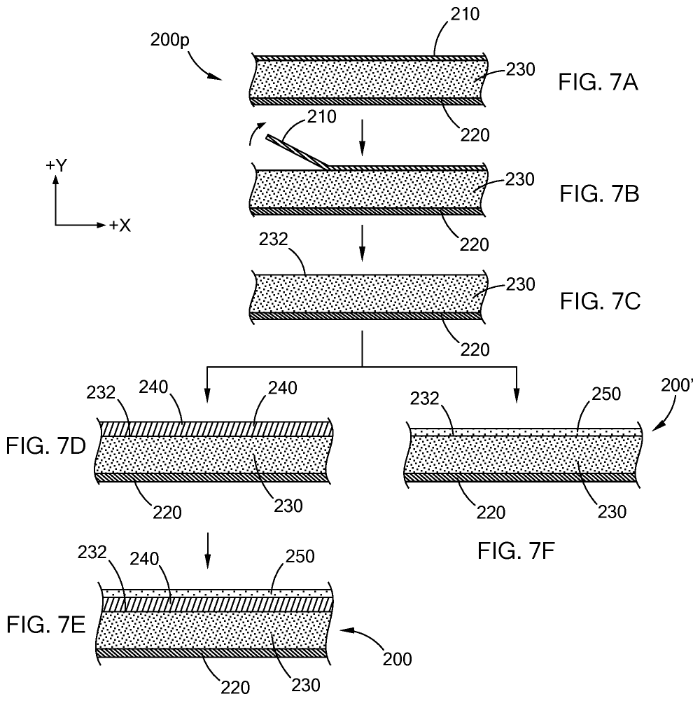

Referring now to FIGS. 7A-7F, a series of steps that may be included in forming a wrapped component 200 from the pre-form 200p is schematically depicted. Particularly, the pre-form 200p formed during step 24 (FIG. 2) and comprising the injection molded removable skin 210, the substrate backing 220, and the FIP foam substrate 230 positioned between and bonded to the injection molded removable skin 210 and the substrate backing 220 is schematically depicted in FIG. 7A. The removal of the injection molded removable skin 210 in step 26 (FIG. 2) is schematically depicted in FIG. 7B and removal of the injection molded removable skin 210 to provide an outer surface 232 on the FIP foam substrate 230 is schematically depicted in FIG. 7C. It should be understood that the surface (not labeled) of the injection molded removable skin 210 in contact with the FIP foam substrate 230 schematically depicted in FIG. 7B may be free of flame treatment and thereby assist in or allow for the removal of the injection molded removable skin 210 from the FIP foam substrate 230 without tearing or ripping of the injection molded removable skin 210 and/or the FIP foam substrate 230. That is, flame treating the surface (not labeled) of the injection molded removable skin 210 that comes into contact with the FIP foam substrate 230 once the FIP foam substrate 230 is formed may prevent removal of the injection molded removable skin 210 from the FIP foam substrate 230 without tearing or ripping.

Referring now to FIGS. 7D-7E, in some aspects of the present disclosure, a spacer layer 240 is bonded to the outer surface 232 as schematically depicted in FIG. 7D and an external wrap 250 is disposed over the spacer layer 240 to form a wrapped component 200 as schematically depicted in FIG. 7E. In one aspect of the present disclosure, the spacer layer 240 is attached directly to the outer surface 232 of the FIP foam substrate 230, e.g., with an adhesive (not shown), and the external wrap 250 is attached directly to the outer surface (+Y direction, not labeled) of the spacer layer 240, e.g., with an adhesive (not shown). While not shown in FIG. 7E, it should be understood that additional layers as described above may be disposed between the substrate backing 220 and the FIP foam substrate 230, between the FIP foam substrate 230 and the spacer layer 240, and/or between the spacer layer 240 and the external wrap 250.

Referring particularly now to FIG. 7F, in other aspects of the present disclosure, the external wrap 250 is bonded to the outer surface 232 without a spacer layer 240 therebetween to form a wrapped component 200′. For example, the spacer layer 240 may be needed for a wrapped component to have a “soft” feel when the skin 116 remains on the substrate 118 as schematically depicted in FIG. 1A. However, when the injection molded removable skin 210 used to form the pre-form 200p and then removed as schematically depicted in FIGS. 7B-7C, the FIP foam substrate 230 itself may provide a soft feel such that the spacer layer 240 is not needed. Accordingly, the external wrap 250 may be attached to the outer surface 232 of the FIP foam substrate 230 without the spacer layer 240 positioned therebetween to form the wrapped component 200′. While not shown in FIG. 7F, it should be understood that additional layers may be disposed between the substrate backing 220 and the FIP foam substrate 230 and/or between the FIP foam substrate 230 and the external wrap 250. One non-limiting example of an additional layer is an adhesive layer. It should also be understood that forming of the wrapped component 200′ without the spacer layer 240 reduces the weight and cost of the wrapped component 200′.

It should be understood from the present disclosure that a method for forming a wrapped component without a dummy skin is provided. The method provides and uses an injection molded skin to form a wrapped component pre-form comprising a substrate backing layer, a FIP foam substrate and the injection molded skin. The injection molded skin is removable, i.e., it is removed from the wrapped component pre-form, and reused to form a plurality of wrapped components. The injection molded skin may be formed with an injection molding machine with a cycle time of less than about 120 seconds, e.g., less than about 60 seconds, and thereby be replaced with a replacement injection molded skin in a timely and cost efficient manner. Also, the injection molded removable skins disclosed herein may be manufactured using injection molding equipment already present within a wrapped component manufacturing facility such that specialized equipment or materials may not be needed to form replacement injection molded skins.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. Also, the term “about” refers to experimental or measurement error/uncertainty for the measurement of values disclosed herein.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of forming a wrapped component comprising:
positioning an injection molded skin in a foam-in-place (FIP) mold;
forming a FIP foam substrate against the injection molded skin;
removing the injection molded skin from the FIP foam substrate; and
bonding an external wrap to the FIP foam substrate to form a wrapped component, wherein the injection molded skin is subsequently used for forming another wrapped component.

2. The method of claim 1, wherein the injection molded skin comprises an injection molded polyolefin skin formed from a thermoplastic elastomer (TPE).

3. The method of claim 2, wherein the TPE comprises a thermoplastic vulcanizate (TPV).

4. The method of claim 2, wherein the injection molded skin comprises a thickness between about 0.5 mm and about 1.5 mm.

5. The method of claim 1, wherein the FIP foam substrate comprises an FIP urethane foam substrate with a thickness between about 2.0 mm and about 20.0 mm.

6. The method of claim 1, wherein the external wrap comprises a leather wrap.

7. The method of claim 1, wherein the external wrap comprises a faux leather wrap.

8. The method of claim 1 further comprising forming a replacement injection molded skin after the injection molded skin is used a predetermined number of times.

9. The method of claim 1, further comprising bonding a spacer layer between and to the FIP foam substrate and the external wrap.

10. A method of forming a plurality of instrument panels comprising the steps of:
a. positioning an injection molded removable skin formed from a polyolefin polymer in a foam-in-place (FIP) mold;
b. forming an FIP urethane foam substrate between a substrate backing layer and the injection molded removable skin;
c. removing the injection molded removable skin from the FIP urethane foam substrate and forming an outer surface on the FIP urethane foam substrate;
d. bonding an external wrap to the outer surface of the FIP urethane foam substrate to form an instrument panel; and
e. repeating steps a-d using the same injection molded removable skin to form additional instrument panels.

11. The method of claim 10 further comprising forming a replacement injection molded removable skin after the injection molded skin is used a predetermined number of times.

12. The method of claim 11, wherein the replacement injection molded removable skin is formed with a cycle time of less than about 120 seconds.

13. The method of claim 10, wherein the injection molded removable skin is formed from a thermoplastic elastomer (TPE).

14. The method of claim 13, wherein the TPE is a thermoplastic vulcanizate (TPV).

15. The method of claim 10, wherein the injection molded removable molded skin comprises a thickness between about 0.5 mm and about 1.5 mm.

16. The method of claim 10, wherein the FIP urethane foam substrate comprises a thickness between about 2.0 mm and about 20.0 mm.

17. The method of claim 10, wherein the external wrap comprises a leather wrap.

18. The method of claim 10, wherein the external wrap comprises a faux leather wrap.

19. The method of claim 10, wherein step d further comprises bonding a spacer layer to the outer surface of the FIP urethane foam substrate and bonding the external wrap to the spacer layer to form the instrument panel such that the external wrap is bonded to the outer surface of the FIP urethane foam substrate through the spacer layer.

20. A method of forming a plurality of instrument panels with an exterior leather or faux leather surface, the method comprising the steps of:
a. positioning an injection molded removable skin comprising a polyolefin polymer and a substrate backing layer in a foam-in-place (FIP)mold, wherein the injection molded removable skin is spaced apart from the substrate backing layer by a distance between about 2.0 mm and about 20.0 mm;
b. forming an FIP urethane foam substrate between the substrate backing layer and the injection molded removable skin;
c. removing the injection molded removable skin from the FIP urethane foam substrate, wherein removing the injection molded removable skin forms an outer surface on the FIP urethane foam substrate;
d. bonding an external wrap to the outer surface of the FIP urethane foam substrate to form an instrument panel; and
e. repeating steps a-d using the same injection molded removable skin as in step a to form at least 10 additional instrument panels.
